(19) United States
(12) Patent Application Publication
(10) Pub. No.: US 2007/0084654 A1
(43) Pub. Date: Apr. 19, 2007

(54) MOTORCYCLE EQUIPPED WITH A HYDROGEN STORING CONTAINER

(75) Inventor: Kenji Kobayashi, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 11/538,360

(22) Filed: Oct. 3, 2006

(30) Foreign Application Priority Data
Oct. 4, 2005 (JP) 2005-290741

(51) Int. Cl. B60L 8/00; B60K 15/00; B62K 11/08

(52) U.S. Cl. 180/65.3; 180/225; 180/69.4

(57) ABSTRACT

An attachment is provided on a vehicle body of a motorcycle and a hydrogen cylinder is equipped on the vehicle body in a detachable manner. The attachment can be connected with a parking stand by a ground wire and the hydrogen cylinder can be grounded via the attachment and the like when the motorcycle is rested on the parking stand. A bracket with a handle and a locked part can be provided on the hydrogen cylinder and a locking part capable of engagement with the locked part can be provided on the attachment. In addition, a connector 34 is provided on the hydrogen cylinder and a connector adapter capable of engagement with the connector is provided on the attachment.

### CROSS-REFERENCE TO RELATED APPLICATIONS

This application claims the priority benefit of Japanese Patent Application No. 2005-290741, filed Oct. 4, 2005, which is hereby incorporated by reference in its entirety.

### BACKGROUND OF THE INVENTION

1. Field of the Invention

The present invention generally relates to a fuel cell powered vehicle. More particularly, the present invention relates to a motorcycle equipped with a hydrogen storing container including a hydrogen storing container for storing hydrogen to be supplied to a fuel cell system.

2. Description of the Related Art

Conventionally, fuel cell powered electric vehicles have been used, in which hydrogen is supplied to a fuel cell system as fuel and the vehicle runs using the electric power produced by the fuel cell system (for instance, see Published Japanese Patent Application No. JP-A-2005-104494). The fuel cell powered electric vehicle includes a fuel tank that stores hydrogen fuel. Hydrogen fuel inform the fuel tank is supplied by a dispensing device that includes a filling hose configured to refill the tank. Also, in the fuel cell driven type electric vehicle, a grounding cable extends from the dispensing device and is connected to a key that is used to open a cap member of the fuel tank. Static electricity charged on a vehicle body is discharged to the ground by the grounding cable and the associated dispensing device when the cap member is contacted by the key.

### SUMMARY OF THE INVENTION

However, in the conventional fuel cell powered electric vehicle mentioned above, grounding the system is complicated because grounding of the vehicle body is accomplished using a long grounding cable that extends from the dispensing device used to fill to permanently mounted hydrogen container on the vehicle. Also, refilling of hydrogen fuel is troublesome because hydrogen fuel is refilled by placing the filling hose into the fuel tank located inside the vehicle body.

Thus, a configuration is desired that can simplify the filling and grounding of a hydrogen fuel system on a vehicle. Thus, one aspect of an embodiment of the present invention involves a motorcycle equipped with a hydrogen storing container. The motorcycle comprises a frame assembly. A parking stand is connected to the frame assembly. A hydrogen storing container is supported by the frame assembly. The hydrogen storing container and the parking stand are electrically connected via a current-carrying member. The hydrogen storing container is grounded via the current-carrying member and the parking stand when the motorcycle is supported by the parking stand. In one preferred configuration, the hydrogen storage container can be mechanically coupled to an attachment member. In a more preferred configuration, the hydrogen storage container is fluidly connected to the attachment member not before the hydrogen storage container is mechanically coupled. In some embodiments, the initial contact of the mechanical coupling acts to ground the hydrogen container and any person handling the hydrogen container prior to the fluid coupling being established.

### BRIEF DESCRIPTION OF THE DRAWINGS

These and other features, aspects and advantages of an embodiment of the present invention will now be described with reference to the drawings of a preferred embodiment, which embodiment is intended to illustrate and not to limit the invention, and in which figures:

FIG. 1 is a perspective view of a motorcycle that is arranged and configured in accordance with certain features, aspects, and advantages of the present invention.

FIG. 2 is a side view of the motorcycle of FIG. 1.

FIG. 3 is a perspective view showing a hydrogen cylinder coupled to an attachment member.

FIG. 4 is a plan view of the hydrogen cylinder and attachment member of FIG. 3.

FIG. 5 is a side view of the hydrogen cylinder and attachment member of FIG. 3.

FIG. 6 is a front view of the hydrogen cylinder and attachment member of FIG. 3.

FIG. 7 is a cross-sectional view showing a connector and a connector adapter before being coupled.

FIG. 8 is a cross-sectional view of the connector fitted to a fitting recess of the connector adapter.

FIG. 9 is a cross-sectional view of the connector further fitted to the fitting recess of the connector adapter.

FIG. 10 is a cross-sectional view of the interconnected connector and connector adapter.

FIG. 11 is a cross-sectional view of a released interconnection between the connector and the connector adapter.

FIG. 12 is a perspective view of an attachment member.

FIG. 13 is a plan view of the attachment member of FIG. 12.

FIG. 14 is a rear view of the attachment member of FIG. 12.

FIG. 15 is a front view of the attachment member of FIG. 12.

FIG. 16 is a side view of the attachment member of FIG. 12.

FIG. 17 is a cross-sectional view of a locking part.

FIG. 18 is a front view of the locking part of FIG. 17.

FIG. 19 is a side view of a ground wire assembly mounted to a motorcycle.

FIG. 20 is a perspective view of a hydrogen cylinder coupled to an attachment member.

FIG. 21 is a side view of the attachment member and a hydrogen cylinder bracket.

### DETAILED DESCRIPTION OF THE PREFERRED EMBODIMENT

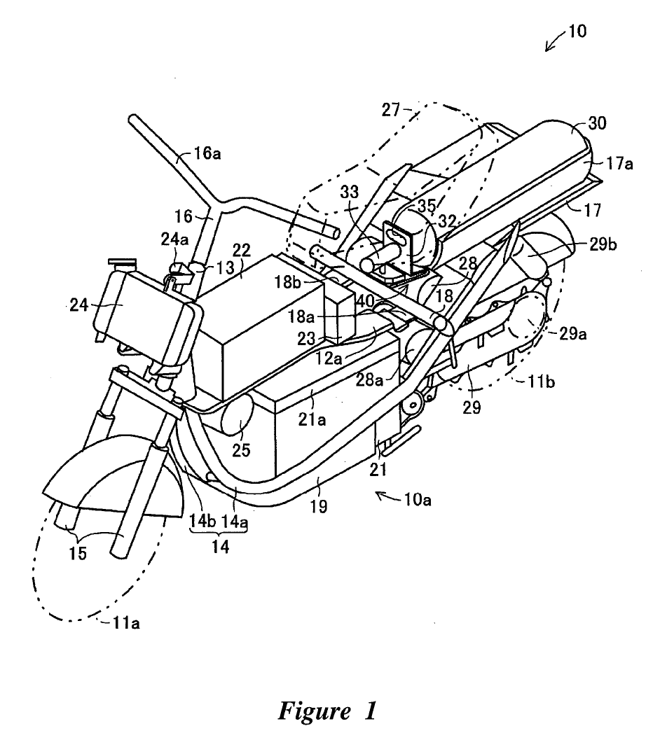

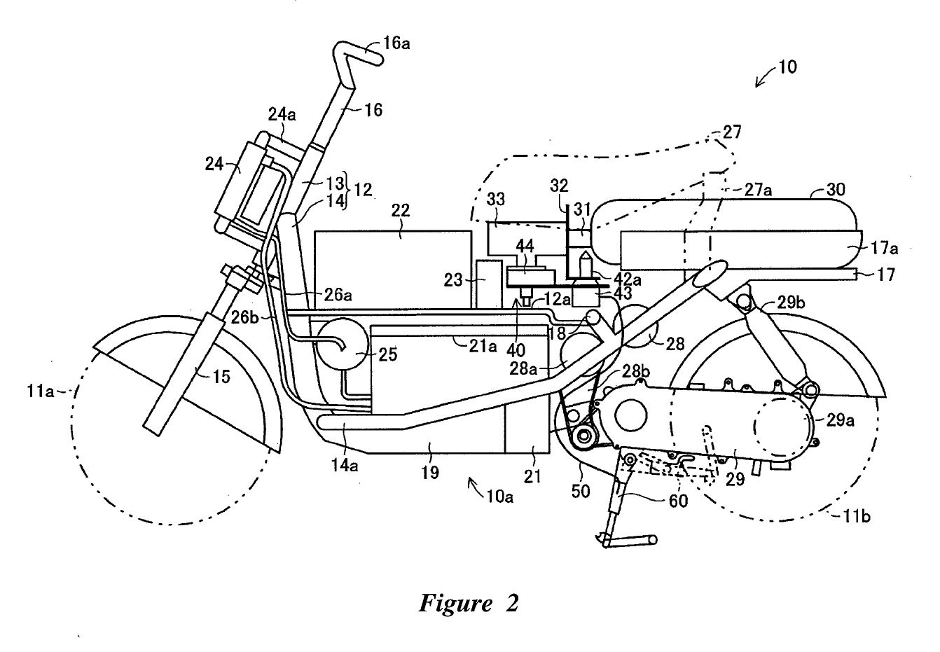

Hereinafter, a motorcycle equipped with a hydrogen storing container arranged and configured in accordance with an embodiment of the present invention will be described with reference to the attached drawings. FIG. 1 and FIG. 2 show an embodiment of a motorcycle 10 that is equipped with a hydrogen storing container. Other vehicle configurations also can be used.

The motorcycle 10 includes a front wheel 11a and a rear wheel 11b and a vehicle body 10a to which the pair of wheels is attached. Also, the vehicle body 10a includes a vehicle body frame 12 defining a major part of the vehicle body 10a and a subframe 12a that is detachably mounted on the vehicle body frame 12. The vehicle body frame 12 is constructed with a head pipe 13 defining a front portion of the vehicle body 10a and a down tube 14 extending rearward from the head pipe 13.

The front wheel 11a is supported in a rotatable manner by the lower end of a front fork 15 that branches into two legs. Preferably, the lower ends of the front fork 15 support lateral sides of a generally horizontal center axle of the front wheel 11a (not shown) in a rotatable manner. Thereby, the front wheel 11a is rotatable around the generally horizontal center axle. The lower end of a steering shaft 16, disposed in the head pipe 13, is coupled to the upper portion of the front fork 15. The steering shaft 16 is supported by the head pipe 13 such that the steering shaft 16 is rotatable around the axis of the head pipe 13, and its upper end extends upward from the head pipe 13. Handlebars 16a preferably are coupled to the upper portion of the steering shaft 16. When the handlebars 16a and the steering shaft 16 are rotated around the axis of the head pipe 13, the front wheel 11a turns left or right according to the amount of rotation of the steering shaft 16.

Handgrips (not shown) are provided on the left and right ends of the handlebars 16a. One of the handgrips preferably is provided such that it is rotatable about a longitudinal axis of the associated end of the handlebar 16a. The rotatable handgrip can be used as a handle and as an accelerator operation element for adjusting an output of a driving motor 29a discussed in greater detail below. The other handgrip preferably is fixed on the handlebars 16a and is used as a handle. Brake levers (not shown) are provided near the handgrips and are configured to be pulled towards the handgrips in order to slow rotation of the front 11a and or rear 11b wheels.

A downtube 14 is preferably configured to include a pair of tubes 14a and 14b. Although tubes preferably are used, any suitable structural member such as a solid or lattice member may be used. The front ends (upper ends) of the tubes 14a and 14b are coupled to sides of the lower portion of the head pipe 13. Each of the tubes 14a and 14b slant downward in a rearward direction and then curve to project generally horizontally in a rearward direction. In the illustrated configuration, the tubes 14a, 14b are increasingly spaced apart as they extend rearward from where they are coupled to the head pipe 13. The rear portion of the tubes 14a and 14b preferably slope upwardly in a rearward direction while maintaining a generally uniform separation from each other. The rear ends of the tubes 14a and 14b are further coupled to a generally planar mounting member 17. In one configuration, the generally planar mounting member 17 extends in a generally horizontal orientation.

In the illustrated configuration, a cross member 18 extends over the upper surfaces of the rear portions of the tubes 14a, 14b. Both the ends of the cross member 18 preferably are formed into a bar shape which is bent into a substantially right angle. Both the bent ends are coupled to the tubes 14a, 14b, and the bent ends project towards the upper surface of the tubes 14a and 14b. Generally planar mounting pieces 18a, 18b are provided on both ends of the cross member 18 and each preferably includes a tapped hole (not shown).

A support board 19 can depend downward from the tubes 14a, 14b and preferably is located on the lower side of the tubes 14a, 14b. The upper surface of the support board 19 preferably defines a recess and a fuel cell container 21 is provided in the recess. The fuel cell container 21 preferably is generally box shaped in which an opening at the upper surface can be opened and closed by a lid 21a. A fuel cell system (not shown) preferably is accommodated inside the fuel cell container 21.

A generally planar subframe 12a can be placed between the front portion of the downtube 14 and the cross member 18. Attachment pieces, with bolt insertion holes, preferably extend forward and rearward and are provided on each side of the front and rear ends of the subframe 12a. A generally planar attachment piece with a tapped hole can be provided at each lateral side (not shown) of the upper portion of the front part of the downtube 14. The front end of the subframe 12a is fixed at the front part of the downtube 14 such that the attachment pieces at both sides of the front end are individually aligned with the attachment pieces provided on the downtube 14. Both attachment pieces are preferably fixed by attachment bolts (not shown) or in any other suitable manner. The rear end of the subframe 12a is fixed at the rear part of the downtube 14 such that the attachment pieces at both the sides of the rear end are individually aligned with the attachment pieces 18a, 18b provided on the cross member 18. Both the attachment pieces 18a, 18b preferably are fixed by attachment bolts (not shown) or in any other suitable manner.

A secondary cell 22 can be mounted slightly forward on the upper surface of the subframe 12a. Also, a control unit 23, which may include a controller, can be fixed on the rearward upper surface of the subframe 12a.

A radiator 24 preferably is mounted on the front portion of the head pipe 13 via a mounting structure 24a. A water pump 25 can be located in front of the fuel cell container 21, behind the front portion of the downtube 14, and below the subframe 12a. The radiator 24 and the water pump 25 can be connected by coolant piping 26a which defines an outbound leg of a coolant flow circuit. As shown in FIG. 2, the coolant piping 26a further extends from the water pump 25 toward the fuel cell container 21 and enters the fuel cell container 21 through the front surface, and then connects to the fuel cell system which is preferably located inside of the container 21.

Coolant piping 26b extends from the fuel cell, through the front surface of the container 21 and to the radiator 24. The coolant piping 26b defines a return leg of a coolant flow circuit. The coolant piping 26a, 26b are preferably attached along lower surfaces of the subframe 12a and the downtube 14. Other configurations also can be used. When the water pump 25 is engaged, the coolant in the radiator 24 flows to the fuel cell system through the coolant piping 26a, thereby cooling the fuel cell. The coolant that absorbed heat while cooling the fuel cell system returns to the radiator 24 through the coolant piping 26b. The coolant is then cooled while passing through the radiator 24.

A tray 17a can define a trough shape with an additional curved wall at its rearward end. The tray 17a preferably includes left and right sides that are provided on the left and right sides of the vehicle body 10a. The tray 17a can be located on the upper surface of the attachment member 17 that is coupled to the rear ends of the tubes 14a and 14b. A hydrogen cylinder 30 can be placed in the tray 17a such that the tray 17a acts receives a hydrogen storing container. The hydrogen storing container can be filled with hydrogen and can fuel the fuel cell system.

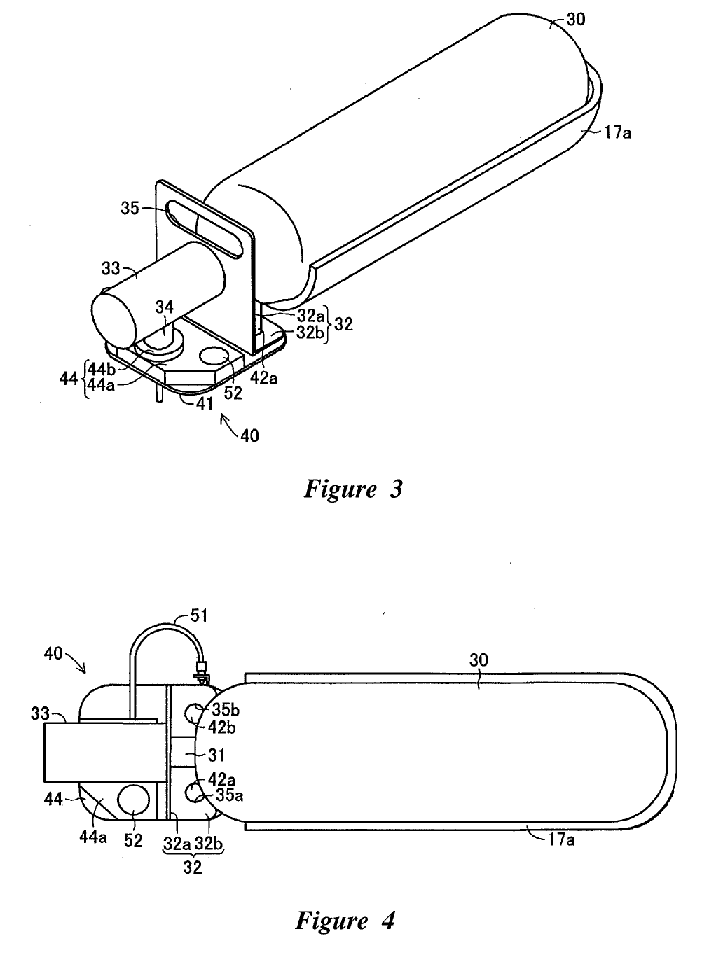

The hydrogen cylinder 30 preferably is connected to the fuel cell system that is positioned in the fuel cell container 21 via an attachment member 40 and any suitable gas piping (not shown). Hydrogen fuel contained inside the hydrogen cylinder 30 preferably is supplied to the fuel cell system as hydrogen gas via the attachment member 40 and the gas piping. The hydrogen cylinder 30 and the attachment member 40 are coupled in FIGS. 3-6.

A bracket 32 and a regulator 33 are positioned at a stem 31 of the hydrogen cylinder 30 when the hydrogen cylinder 30 is mounted to the attachment member 40. The regulator 33 is used to regulate pressure as the hydrogen is released into the fuel cell system from the hydrogen cylinder 30. The stem 31 preferably is formed on a forward portion of the hydrogen cylinder 30. A connector 34 can be provided at the center of the lower portion of the regulator 33. Any suitable configuration can be used.

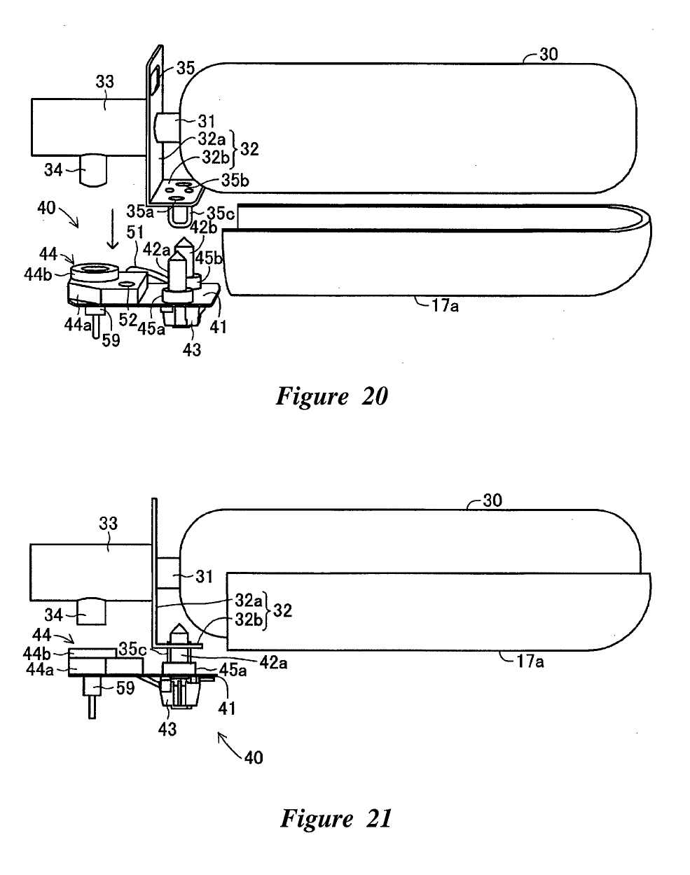

The hydrogen cylinder 30 is preferably coupled to the attachment member 40 via the bracket 32 and the connector 34. The illustrated bracket 32 comprises a generally vertical portion 32a that can be connected or fixed to an outer peripheral surface of the stem 31. The generally vertical portion 32a is further configured to cross the stem 31 at an approximately right angle. A generally horizontal piece 32b extends toward the main body of the hydrogen cylinder 30 from the lower portion of the generally vertical piece 32a. A mounting hole also can be provided near the center of the generally vertical piece 32a. The edge defining the hole can be fixed to the stem 31 in order to secure the generally vertical piece 32a to the stem 31. A handle 35 configured with a laterally elongated hole or slot can be formed in the upper portion of the generally vertical piece 32a. Other types of handles or handgrips also can be used. Insertion holes 35a and 35b can be formed in both lateral sides of the generally horizontal portion 32b. A locking portion 35c, which can be formed in approximately U-shape configuration (see FIG. 20), can be located along a lower surface of the generally horizontal piece 32b between the insertion holes 35a and 35b. The locked part 35c can be oriented on the horizontal piece 32b in a generally front-and-rear direction.

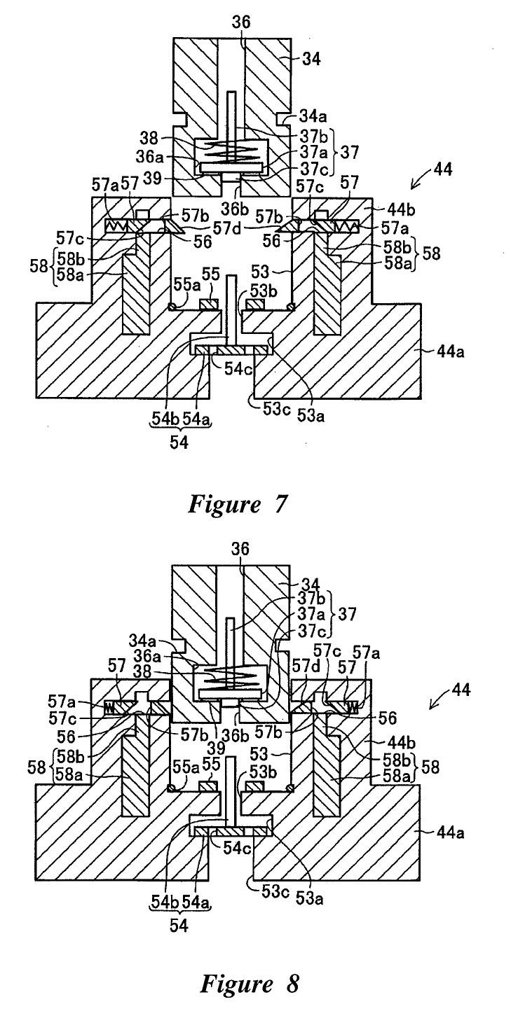

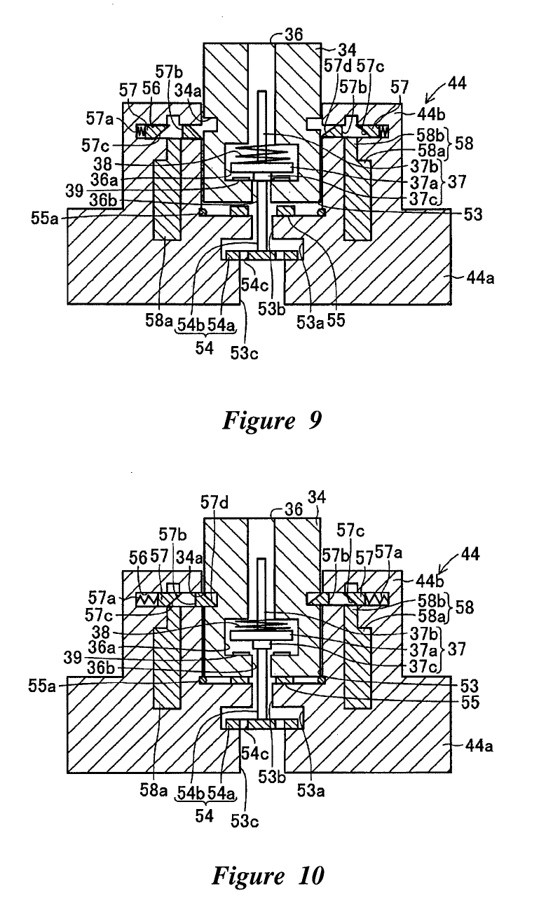

A cross section of the connector 34 can be as shown in FIGS. 7-11. The connector 34 preferably is configured with a drum shaped body with a gas supplying path 36 for supplying hydrogen gas formed along a central axis. An accommodating recess 36a is formed at a lower inside portion of the connector 34 such that its diameter is larger than the diameter of the gas supplying path 36. Also, a gas emitting part 36b, with a diameter slightly smaller than the diameter of the gas supplying path 36, is formed below the accommodating recess 36a of the connector 34. A shutoff valve 37 and a spring 38 for biasing the shutoff valve 37 downward preferably are located at least partially within the accommodating recess 36a.

The shutoff valve 37 comprises a disc-shaped valve body 37a that is movable in a vertical direction in the accommodating recess 36a. The shutoff valve 37 also includes a cylindrical portion 37b that extends upward from the center of the upper surface of the valve body 37a and is located in the gas supplying path 36. A disc-shaped part 37c preferably projects downward from the center of the lower surface of the valve body 37a. The disc-shaped part 37c enters into the gas emitting part 36b when the valve body 37a is positioned in the lower portion of the accommodating recess 36a. The disc-shaped part 37c lifts up from the gas emitting part 36b and moves into the accommodating recess 36a when the valve body 37a is positioned in the upper portion of the accommodating recess 36a as shown in FIG. 10.

The spring 38 preferably is a coil spring and is located between the upper surface of the accommodating recess 36a and the upper surface of the valve body 37a. The spring 38 preferably is positioned around the cylindrical part 37b of the valve 37. The spring 38 biases the shutoff valve 37 downward to reduce the likelihood of gas flow through the gas emitting part 36b.

A sealing member 39 can be provided on the bottom surface of the accommodating recess 36a, on a corresponding lower surface of the valve 37 or both. In the illustrated configuration, the sealing member 39 is on the bottom surface of the accommodating recess 36a. The lower surface of the valve body 37a contacts the sealing member 39 when the shutoff valve 37 is urged downward by the spring 38. Thus, the sealing member 39 improves the likelihood that gas flow through the gas emitting part 36b will be interrupted. A groove part 34a for engagement also is formed in a location positioned slightly upward of the accommodating recess 36a on the outer peripheral surface of the connector 34.

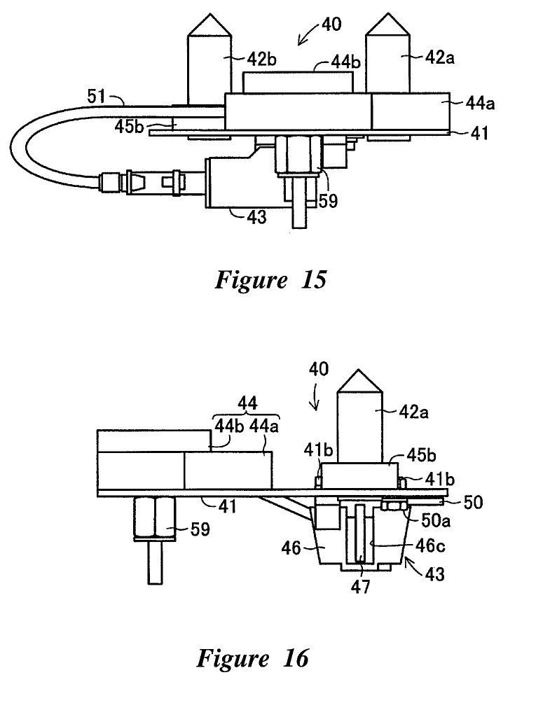

An embodiment of the attachment member 40 is shown in FIGS. 12-16. In one configuration, the rear portion defines the coupling part and the front portion defines the connecting part for transfer of hydrogen. The attachment member 40 preferably is configured such that a pair of guide shafts 42a, 42b, a locking part 43 and a connector adopter 44 are provided on a base plate 41.

In the illustrated embodiment, the guide shafts 42a, 42b are formed such that they are spaced apart and extend through the base plate 41 to a lower surface of the base plate 41 at both lateral sides. The guide shafts 42a, 42b extend upward from the base plate 41, and the upper end is preferably formed into a cone shape. The guide shafts 42a and 42b can be inserted into the insertion holes 35a, 35b of the bracket 32. The flanges of the insertion holes 35a, 35b of the bracket 32 contact the guide shafts 42a, 42b when they are inserted into the insertion holes 35a, 35b. The guide shafts 42a, 42b and the insertion holes 35a, 35b of the bracket 32 preferably act as a locating mechanism.

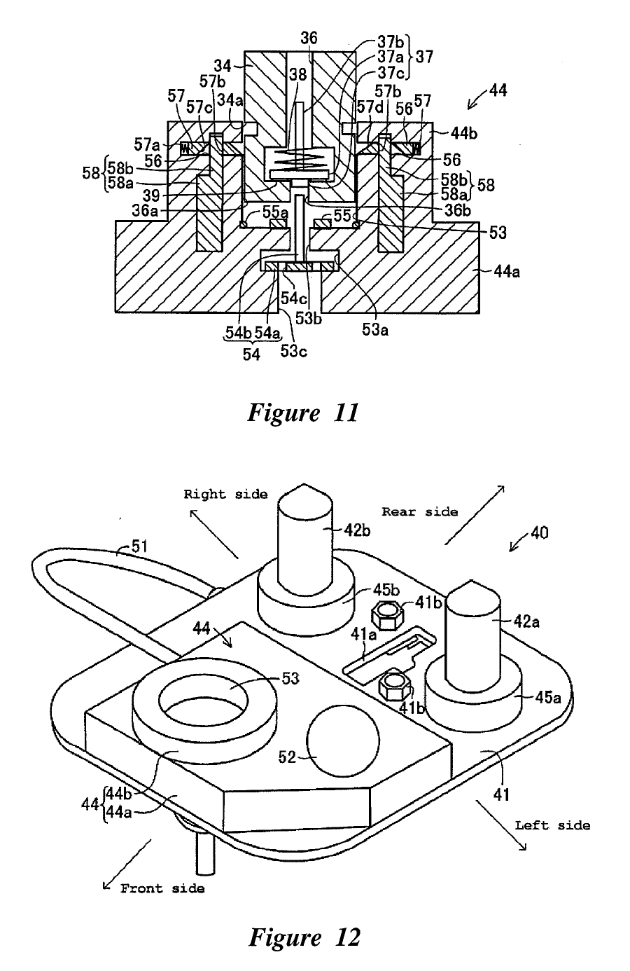

With continued reference to FIGS. 11-16, cushions 45a, 45b are provided on the upper surface of the illustrated base palate 41 around the peripheries of the guide shafts 42a, 42b. An impact force produced when the guide shafts 42a, 42b are inserted into the insertion holes 35a, 35b and the bracket 32 is coupled to the attachment member 40 is preferably reduced by the cushions 45a, 45b. An elongated rectangular hole 41a can be located in the base plate 41 between the guide shafts 42a and 42b. The hole 41a preferably is elongated in a front-and-rear direction. In the illustrated configuration, a locking part 43 is attached below the hole 41a on the lower surface of the base plate 41 and is preferably fixed by a bolt 41b or in any other suitable manner.

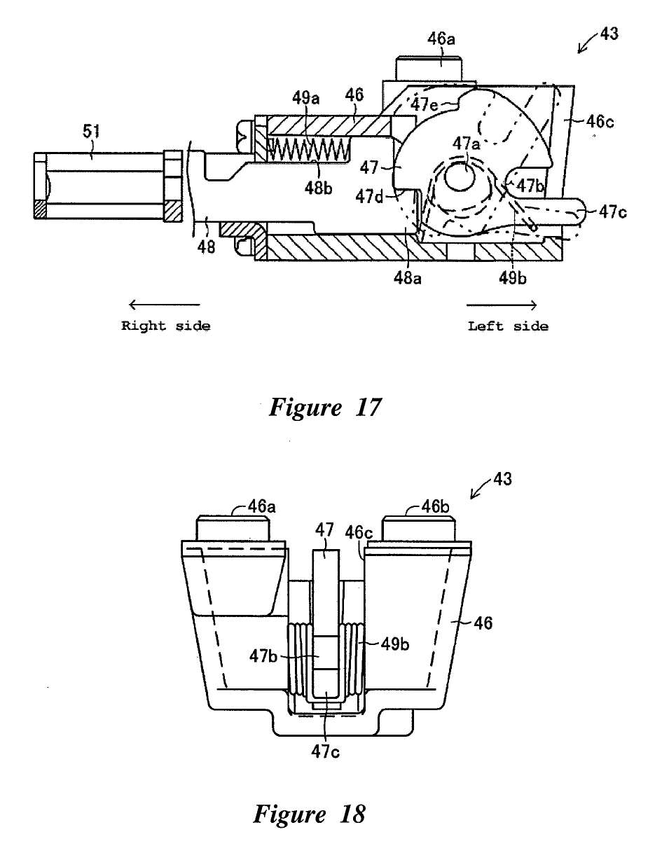

The locking part 43 is shown in greater detail in FIGS.17 and 18 and includes a casing member 46. The casing member 46 includes attachment parts 46a, 46b that attach to the lower surface of the base plate 41. The casing member 46 also includes a locking plate 47, a lever 48, and springs 49a, 49b.

The casing member 46 is formed into approximately a rectangular-box-shape which extends in a transverse direction (i.e., left to right relative to the vehicle body 10a). The casing member 46 is illustrated with the right side in FIG. 17 as the left side of the vehicle and the left side of FIG. 17 as the right side of the vehicle body. A notch recess 46c communicates with the hole 41a. The notch recess 46c preferably is located in the central part of the casing member 46 and extends in a front-and-rear direction on the left side surface of the casing member 46 and further extends to the upper surface. The locking plate 47 preferably is a rotatable plate placed in a rotatable manner on a shaft 47a that spans over both the front and rear sides of the casing member 46.

The locking plate 47 includes an engagement recess 47b that the locked part 35c is capable of engaging with. The locking plate 47 also includes an engagement portion 47c that projects beyond (e.g., to the left side in FIG. 17) of the edge on the lower side of the engagement recess 47b. A locking recess 47d is formed generally opposite of the engagement recess 47b and is located on the outer periphery of the locking plate 47 in the left-and-right direction of FIG. 17. A stopper recess 47e is formed on the upper surface of the locking plate between the engagement recess 47b and the locking recess 47d.

The lever 48 is configured with a bar shaped body and includes a locking part 48a at a lower portion of the tip of the lever 48. The locking part 48a is capable of engagement with the locking recess 47d. The lever 48 also includes a spring accommodating recess 48b which is formed in the upper part of the lever 48. The lever is further configured to move in the front-and-rear direction inside the casing member 46.

The spring 49a is preferably a coil spring and is accommodated between the casing member 46 and the side of the accommodating recess 48b. The spring is configured to bias the lever 48 to the left side. The spring 49b is preferably a torsional spring which includes locking parts that are formed at both ends. The spring 49b preferably urges the locking plate 47 counterclockwise. A cable 51 extends from the rear end of the lever 48. The end of the cable 51 is connected to a releasing device 52 that is located on a base part 44a of the connector adapter 44, which is formed at the front side of the base plate 41. The releasing device 52 includes a pushbutton which allows the lever 48 to be moved rearward when the pushbutton is pushed.

When the locked part 35c is not locked to the locking part 43, the locking plate 47 is biased by the spring 49b so that the engagement recess 47b faces upward as shown by a dashed line in FIG. 17. When the stopper recess 47e contacts a predetermined part in the casing member 46, the locking plate 47 preferably can not rotate further in the counterclockwise direction of FIG. 17. When the bracket 32 is lowered, the locked part 35c engages with the engagement recess 47b. When the bracket 32 is further lowered, against the biasing force of the spring 49b, the locking plate 47 rotates in the clockwise direction in of FIG. 17.

The lever 48 is preferably biased forward by the spring 49a when the locking recess 47d rotates to the locking part 48a and the locking recess 47d and the locking part 48a engage as shown by the solid line in FIG. 17. After the engagement, the locked part 35c continues to be engaged with the engagement recess 47b and continues to be locked to the locking plate 47. When the engagement between the locked part 35c and the locking plate 47 is released, the lever 48 is moved rearward. The activation of the releasing device 52 preferably releases the engagement between the locking recess 47d and the locking part 48a. The locking plate 47 thus rotates counterclockwise by the biasing force of the spring 49b as shown by the dashed line in FIG. 17. The locked part 35c can then be disengaged from the locking part 43 when the bracket 32 is lifted.

With reference to FIG. 16, a mounting member 50a is located adjacent to the locking part 43 on the lower surface of the base plate 41. The mounting member 50a receives one end of the ground wire 50 which is then connected to the attachment member 40 by the mounting member 50a.

With continued reference to FIGS. 7-11, the connector adapter 44 includes the base part 44a and a drum part 44b. The drum part 44b is preferably formed above the base part 44a and is relatively short. The inside of the drum part 44b defines a recess 53 in which the connector 34 can fit. The inside of the drum 44b also defines an accommodating recess 53a that receives a shutoff valve releasing pin 54. The shutoff valve releasing pin 54 is preferably a protruding element and is located centrally below the fitting recess 53 in an up-and-down direction. The fitting recess 53 and the accommodating recess 53a are in communication by a connecting hole 53b. A gas passageway 53c is also centrally located between the lower end of the accommodating recess 53a and the lower surface of the base part 44a.

The diameter of the accommodating recess 53a is preferably smaller than the diameter of the fitting recess 53. Also, The diameter of gas passageway 53c is preferably smaller than the diameter of the accommodating recess 53a and the diameter of the connecting hole 53b is preferably smaller than the diameter of the gas passageway 53c. The fitting recess 53, connecting hole 53b, accommodating recess 53a, and gas passageway 53c are preferably in sequential communication.

The shutoff valve releasing pin 54 preferably includes a disc-shaped valve body 54a movable in a vertical direction in the accommodating recess 53a. The shutoff valve releasing pin 54 preferably also includes a pressing pin 54b which extends upward into the fitting recess 53 and passes through the connecting hole 53b from a central upper surface of the valve body 54a. A gas passageway 54c is preferably included with the valve body 54a for passing hydrogen gas to the gas passageway 53c from the accommodating recess 53a.

A ring-shaped sealing member 55 is preferably located on the upper peripheral surface of the connecting hole 53b. An attachment groove is located in the outer peripheral edge of the bottom surface of the fitting recess 53 and is configured to receive an O-ring 55a.

When the connector 34 is fitted into the fitting recess 53, the pressing pin 54b of the shutoff valve releasing pin 54 contacts with the disc-shaped part 37c of the shutoff valve 37, and the valve body 37a of the shutoff valve 37 is moved upward in the accommodating recess 36a. As a result of the aforementioned sequence of functions, the gas supplying path 36 of the connector 34 and the fitting recess 53 of the connector adapter 44 are placed in communication.

A plurality of guide holes 56 are formed in the inner peripheral surface of the drum part 44b such that the guide holes 56 extends from the inner peripheral surface of the drum part 44b toward the outer peripheral surface of the drum part 44b. A wedge-shaped engaging part 57 is biased by a spring 57a that is disposed in the deeper side of the guide hole 56 and biases the wedge-shaped engaging part 57 toward the fitting recess 53. A guide hole 57b is also provided such that it passes through the wedge-shaped engaging part 57 at the near-center of the wedge-shaped engaging part 57 in an up-and-down direction. The side surface at the rear of the guide hole 57b is preferably a sloped surface 57c in which the width of the guide hole 57b at the upper part is smaller than the width at the lower part.

A lock releasing mechanism 58 is provided such that it can be drawn up the sloped surface 57c of the guide hole 57b. The mechanism 58 is located near the center of the guide hole 56 and is configured to move the wedge-shaped engaging part 57 to the deeper side of the guide hole 56. The lock releasing mechanism 58 preferably includes a drum-shaped base 58a and a thin drum-shaped cam 58b located above the drum-shaped base 58a. The upper end of the drum-shaped cam 58b is preferably formed into a smooth surface with a projection and a recess. The lock releasing mechanism 58 is connected to the releasing device 52. The lock releasing mechanism 58 rotates around a central vertical axis by the actuation of the releasing device 52. The rotation moves the wedge-shaped engaging part 57 toward the deeper side of the guide hole 56 against the spring 57a when the projection at the upper end of the drum-shaped cam 58b is drawn up the sloped surface 57c of the wedge-shaped engaging part 57. A sloped surface 57d facing upward is formed at the tip of the wedge-shaped engaging part 57 which is capable of engaging with the groove part 34a of the connector 34.

When the connector 34 is placed into the fitting recess 53, the pin 54b of the shutoff valve releasing pin 54 contacts the disc-shaped part 37c of the shutoff valve 37. The contact moves the valve body 37a of the shutoff valve 37 upward in the accommodating recess 36a. Thus, the gas supplying path 36 defined in the connector 34 and the fitting recess 53 defined in the connector adapter 44 are placed into communication.

A plurality of guide holes 56 are formed in the inner peripheral surface of the drum part 44b such that the guide holes 56 extend from the inner peripheral surface of the drum part 44b toward the outer peripheral surface of the drum part 44b. A wedge-shaped engaging part 57 and a spring 57a are disposed inside of the guide hole 56. The spring 57a biases the wedge-shaped engaging part 57 toward the fitting recess 53. A guide hole 57b is also provided such that it passes through the wedge-shaped engaging part 57 at the near-center of the wedge-shaped engaging part 57 in an up-and-down direction. The side surface at the rear of the guide hole 57b preferably defines a sloped surface 57c in which the width of the guide hole 57b at the upper part is smaller than the width at the lower part.

A lock releasing mechanism 58 is provided such that it can be drawn up the sloped surface 57c of the guide hole 57b. The mechanism 58 is located near the center of the guide hole 56 and is configured to retract the wedge-shaped engaging part 57 against the biasing force of the spring 57a. The lock releasing mechanism 58 preferably includes a drum-shaped base 58a and a thin drum-shaped cam 58b located above the drum-shaped base 58a. The upper end of the drum-shaped cam 58b is preferably formed into a generally smooth surface with a projection and a recess.

The lock releasing mechanism 58 can be connected to the releasing device 52. The illustrated lock releasing mechanism 58 rotates around a central generally vertical axis when actuated by the releasing device 52. The rotation retracts the wedge-shaped engaging part 57 into the guide hole 56 against the spring 57a when the projection at the upper end of the drum-shaped cam 58b is drawn up the sloped surface 57c of the wedge-shaped engaging part 57. A sloped surface 57d facing upward can be formed at the tip of the wedge-shaped engaging part 57. The sloped surface 57d can engage with the groove part 34a of the connector 34.

When the connector 34 enters the fitting recess 53, the periphery on the lower end of the connector 34 pushes against the sloped surface 57d of the tip of the wedge-shaped engaging part 57. The connector 34 moves down and pushes the wedge-shaped engaging part 57 out of the way (i.e., deeper into the guide hole 56). When the connector 34 continues to move down, as shown from FIGS. 7-10, and the groove part 34a of the connector 34 reaches the position of the wedge-shaped engaging part 57, the wedge-shaped engaging part 57 moves toward the fitting recess 53 and engages with the groove part 34a due to the biasing force of the spring 57a. As shown in FIG. 10, the connector 34 can be fixed to the connector adapter 44, and the gas supplying path 36 of the connector 34 and the fitting recess 53 of the connector adapter 44 are placed in communication.

In the configuration shown in FIG. 10, the sealing member 55 preferably is compressed to the height of the O-ring 55a by the lower surface of the connector 34. The gap between the outer peripheral surface of the connector 34 and the inner peripheral surface of the fitting recess 53 is substantially sealed by the sealing member 55 and the O-ring 55a. When the engagement between the connector 34 and the connector adapter 44 is to be released, the lock releasing mechanism 58 rotates by the actuation of the releasing device 52, as shown in FIG. 11. During the release, the projection on the upper end of the drum-shaped cam 58b pushes the sloped surface 57c aside, enters into the guide hole 57b, and retracts the wedge-shaped engaging part 57 into the guide hole 56 against the spring 57a. Thus, as described above, the locking mechanisms in one configuration may include the groove part 34a, the wedge-shaped engaging part 57, the locked part 35c and the locking part 43.

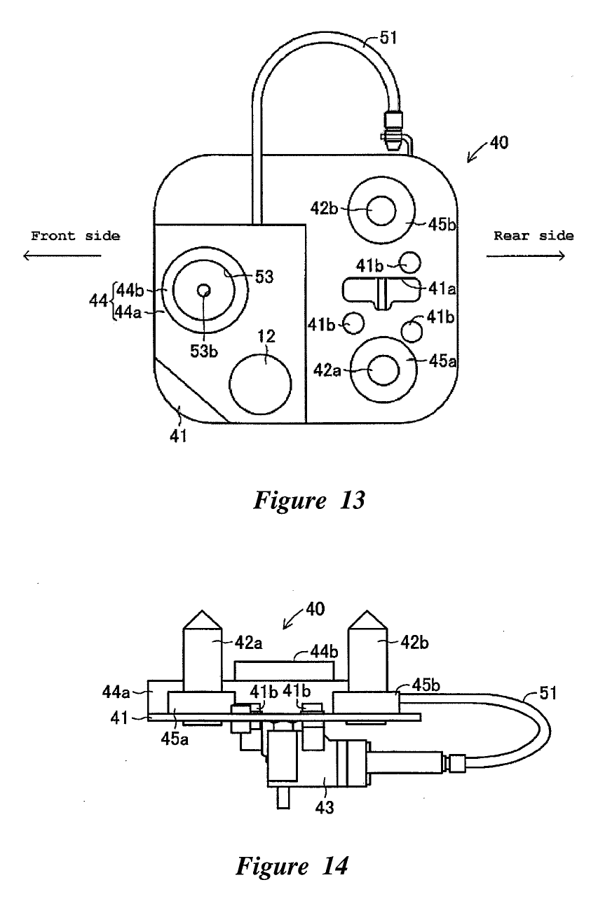

With reference to FIGS. 13-16, a connecting member 59 (see FIG. 16) is attached on the lower surface of the base plate 41 in a location corresponding to the gas passageway 54c. Gas piping is connected to the connector adapter 44 via the connecting member 59. In other words, the connecting member 59 can be used to join the connector adapter 44 to gas piping (not shown).

With reference again to FIGS. 1 and 2, a seat 27 can be located above the front portion of the hydrogen cylinder 30. The seat 27 can be coupled to the rear side of the downtube 14 by a supporting member 27a. An air cleaner 28 can be located rearward of the cross member 18 at the rearward portion of the downtube 14. An air compressor 28a can be located forward of the cross member 18 at the rear portion of the downtube 14. The air cleaner 28 and the air compressor 28a, and the air compressor 28a and the fuel cell system preferably are connected respectively by gas piping (not shown). The outside air preferably is aspirated by the air cleaner 28 when the air compressor 28a is operated to supply air to the fuel cell system. Foreign objects in the air thus can be removed from the air supply while passing through the air cleaner 28.

A rear arm, which can be configured with a pair of arm members that extend rearward (not shown), is connected to the lower part of the rear portion of the illustrated downtube 14 by a coupling member 28b. Both sides of the horizontal center shaft of the rear wheel 11b can be supported for rotation by the rear ends of the arm members of the rear arm. The rear wheel 11b is rotatable around the horizontal center shaft. A motor unit 29 is placed on the outside surface of one of the arm members of the rear arm and preferably covers at least a portion of the arm member. The illustrated motor unit 29 includes the driving motor 29a and a speed reducer that are actuated using electricity produced by the fuel cell system. The rear wheel 11b is rotated by the driving motor 29a, thus powering the motorcycle 10.

Rear cushions 29b, or shock absorbers, can be located between the rear ends of the downtubes 14 and the upper part of the rear end of the rear arm. The rear side of the rear arm is capable of displacing with the extension and contraction of the rear cushion 29b. A drum brake (not shown) can be located at a side of the inside surface of the motor unit 29. The driving motor 29a operates under the commands provided through rotation of the handgrip and control output from controller which is included in the control unit 23. The driving motor 29a, in turn, automatically produces a drive force for the rear wheel 11b. The control output from the controller preferably stops actuation of the driving motor 29a when the brake lever is operated.

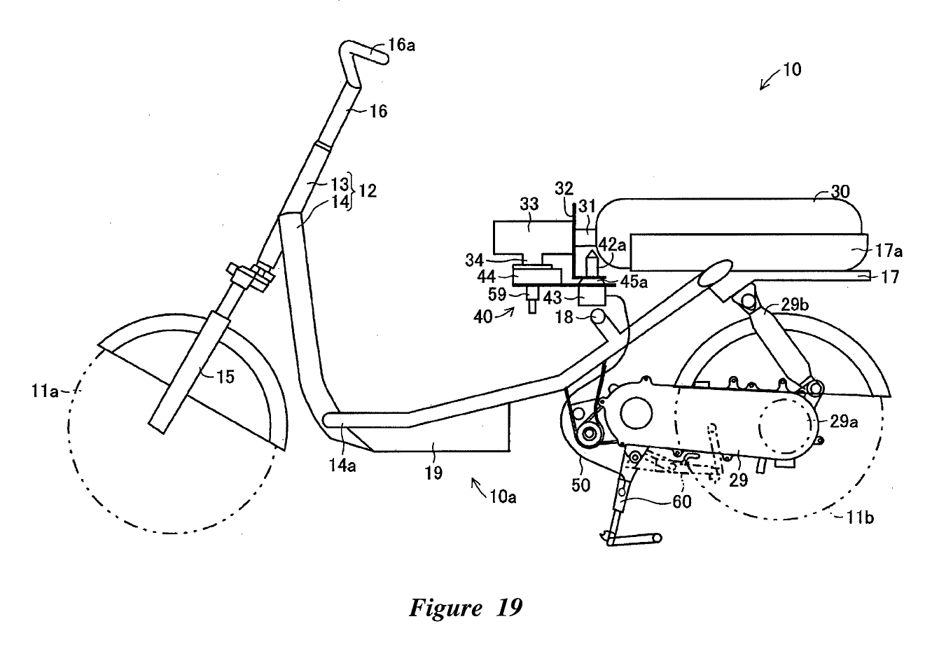

The motorcycle 10 includes a pivoting type parking stand 60 for keeping the motorcycle 10 substantially upright while parked. When the motorcycle 10 is to run, the parking stand 60 is lifted up as shown by the dashed line in FIG. 2. When the motorcycle 10 is to be parked, the parking stand 60 is rotated downward as shown by the solid line in FIG. 2, and the motorcycle 10 can then be supported by the parking stand 60. An end of a ground wire 50 extending from the attachment 40 can be connected to the parking stand 60. Therefore, when the motorcycle 10 is parked, the attachment 40 is grounded by the ground wire 50 and the parking stand 60. This is shown with greater clarity in FIG. 19 which omits the fuel cell system and each device included for actuating the fuel cell system to make one preferred routing of the ground wire 50 clear.

With reference again to FIGS. 1 and 2, the fuel cell system urges the oxygen in the air supplied from the air compressor 28a and the hydrogen supplied from the hydrogen cylinder 30 to react to produce water and electricity. The secondary cell 22 discharges as needed as a supplemental power source. The controller controls the water pump 25, the air compressor 28a, and the driving motor 29a based on the operation of the handgrip by a rider and protocols set beforehand. In addition, though not shown, the motorcycle 10 includes covering members for covering the outside of predetermined parts so that the radiator 24 and each device of the hydrogen cylinder 30 and so forth as generally obscured from view for improved aesthetics. The motorcycle 10 also can include a power source switch for starting (not shown).

With reference to FIGS. 1-2, when a rider desires to ride the motorcycle 10, a rider preferably first straddles the seat 27. Next, the power source switch is turned on. Air is then supplied from the air compressor 28a to the fuel cell system, hydrogen is supplied from the hydrogen cylinder 30, and the fuel cell system makes the oxygen and the hydrogen react to produce electricity. The fuel cell system is cooled down by the coolant sent from the water pump 25 such that the fuel cell system temperature can be maintained within a desired range or substantially at a predetermined temperature. The fuel cell system exhaust to the outside the water produced in the reaction between oxygen and hydrogen.

Next, the handgrip is operated according to the velocity desired by the rider. Thereby, the controller actuates the driving motor 29a, which produces drive force for the rear wheel 11b. When the speed of the motorcycle 10 is desired to be reduced, the brake lever is operated as needed, thereby reducing the speed of the motorcycle 10. When operation of the motorcycle 10 is finished, the power source switch is turned off and the parking stand 60 is pivoted downward so as to be grounded. The motorcycle 10 can then be kept upright by the parking stand 60.

With reference to FIGS. 3-6 and 20-21, when the hydrogen cylinder 30 is emptied or substantially emptied and the hydrogen cylinder 30 is exchanged, the releasing device 52 is preferably actuated while the parking stand 60 is down and grounded. During the release, the locked part 35c and the locking part 43 are unlocked and the connector 34 and the connector adapter 44 are released from each other. Then, the hydrogen cylinder 30 is detached from the vehicle body 10a preferably with the handle 35 of the bracket 32 and the main body of the hydrogen cylinder 30 being held. Next, preferably while holding the handle 35 of a new hydrogen cylinder 30 filled with hydrogen fuel and the main body of the hydrogen cylinder 30, the hydrogen cylinder 30 is placed on the top of the tray 17a as shown in FIG. 20.

The new hydrogen cylinder 30 can be pushed down as shown in FIG. 21 so that the insertion holes 35a, 35b of the bracket 32 are aligned to the guide shafts 42a, 42b of the attachment 40 and the connector 34 is aligned to the fitting recess 53 of the connector adapter 44. At this moment, the peripheries of the insertion holes 35a, 35b contact the guide shafts 42a, 42b, and any static electricity built up on the hydrogen cylinder 30 and/or on a worker is discharged to the ground through the bracket 32, the attachment 40, the ground wire 50, and the parking stand 60.

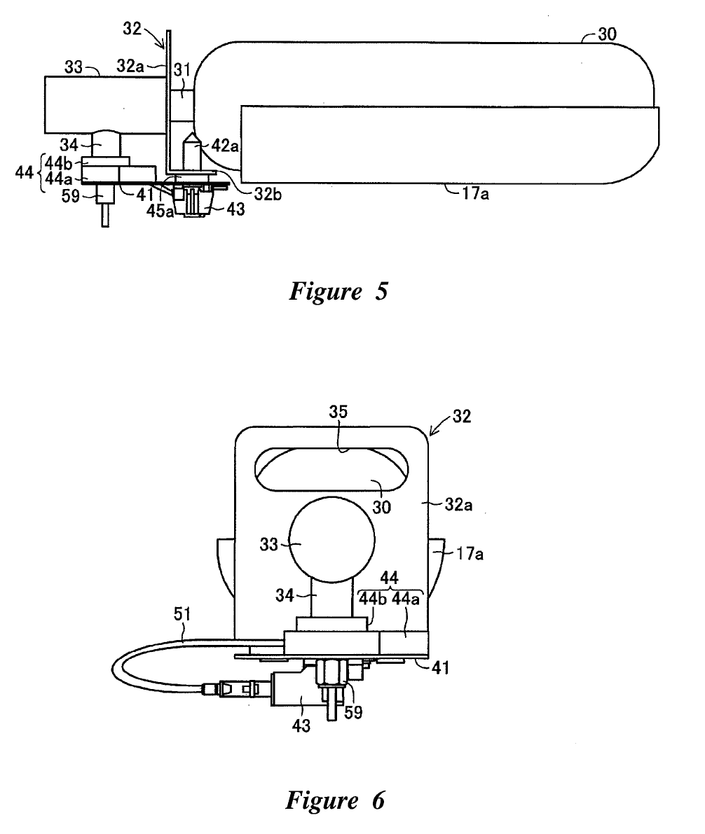

In addition, although the surface of the hydrogen cylinder 30 is preferably coated with glass fiber and electrically insulated, the inside of the hydrogen cylinder 30 is made of aluminum or any suitable metal and may become charged with static electricity. Therefore, the static electricity build up on the hydrogen cylinder 30 can be discharged to the ground by grounding. When the hydrogen cylinder 30 is pushed down, the hydrogen cylinder 30 is supported by the tray 17a, the locked part 35c is locked with the locking part 43, and the connector 34 is engaged with the connector adapter 44. Thereby, the hydrogen cylinder 30 is fixed while being coupled to the attachment 40 and connected to the fuel cell system by the attachment 40 and the gas piping, as shown in FIG. 5.

Preferably, during the aforementioned sequence of events, the impact between the bracket 32 and the attachment 40 is buffered by the cushions 45a, 45b. Also, rotation of the hydrogen cylinder 30 in the tray 17a is generally prevented or greatly reduced by the bracket 32. Thereby, a substantially stable installation of the hydrogen cylinder 30 is accomplished. If the hydrogen cylinder 30 is put on the floor, the likelihood of rotation or rolling of the hydrogen cylinder 30 is reduced because of the shape of the bracket 32. The shape of the bracket 32 also facilitates easy storage of the hydrogen cylinder 30.

As described above, the attachment 40 in the illustrated motorcycle 10 preferably is grounded by the ground wire 50 and the parking stand 60 when the motorcycle 10 is parked with the parking stand 60 rotated downward. When the bracket 32 of the hydrogen cylinder 30 contacts the guide shafts 42a, 42b, the static electricity that may be built up on the hydrogen cylinder 30 and/or a worker can be discharged to the ground via the ground wire 50 and the parking stand 60. Therefore, special activities for grounding are reduced with this configuration.

The hydrogen cylinder 30 preferably is a cartridge type in which refilling of hydrogen fuel can be accomplished by replacing an empty hydrogen cylinder 30 with a new hydrogen cylinder 30 filled with hydrogen fuel. Thus, a complicated refilling activity of hydrogen fuel with a filling hose and the like is not necessary. In addition, because the bracket 32 touches the attachment 40 connected to the ground wire 50 before the connector 34 engages with the connector adapter 44, grounding is made when the hydrogen cylinder 30 touches the attachment 40. Grounding thus occurs before the hydrogen fuel is supplied, and grounding can be made early during the refueling process.

Coupling the hydrogen cylinder 30 to the attachment 40 is easier because the interconnection between the connector 34 and the connector adapter 44 and the locking between the locked part 35c and the locking part 43 happen during movement of the hydrogen cylinder 30 toward the attachment 40 in the motorcycle 10. In addition, a secure coupling can be achieved because the coupling between the hydrogen cylinder 30 and the attachment 40 can be made with the engagement between the locked part 35c and the locking part 43 and with the engagement between the connector 34 and the connector adapter 44.

Certain features, aspects and advantages of the present invention can be used in other manners and in other applications. In addition, various modifications may be made to the illustrated motorcycle embodiment. For instance, although a hydrogen storing container is configured with the hydrogen cylinder 30 in the embodiment described above, the hydrogen storing container can be devices other than a cylinder as long as they can store hydrogen. Locking mechanisms are provided in both the combination between the locked part 35c and the locking part 43 and the combination between the groove part 34a of the connector 34 and the wedge-shaped engaging part 57 of the connector adapter 44. However, a locking mechanism can be provided on either one of those or in a completely different manner. In addition, the illustrated hydrogen cylinder 30 comprises a cartridge type and can be detachable from the vehicle body 10a in the embodiment described above. However, the hydrogen cylinder 30 can be configured with one capable of being refilled with hydrogen fuel while being fixed on the vehicle body 10a.

What is claimed is:

1. A motorcycle equipped with a hydrogen storing container, the motorcycle comprising a frame assembly, a parking stand connected to the frame assembly, a hydrogen storing container supported by the frame assembly, the hydrogen storing container and the parking stand being electrically connected via a current-carrying member, and the hydrogen storing container being grounded via the current-carrying member and the parking stand when the motorcycle is supported by the parking stand.

2. The motorcycle of claim 1, wherein the current-carrying member comprises an attachment member, the attachment member being electrically conductive and being supported by the frame assembly, the current-carrying member also comprising a ground wire that connects the attachment member to the parking stand, the hydrogen storing container being detachably coupled to the attachment member and the hydrogen storing container being connected to the parking stand by the attachment and the ground wire when the hydrogen storing container is coupled to the attachment.

3. The motorcycle of claim 2, wherein the hydrogen storing container and the attachment member are mechanically coupled and fluidly coupled such that the hydrogen storing container can be interlocked with the attachment member and such that hydrogen contained within the hydrogen storing container can be transferred through the attachment member, the ground wire being connected to the mechanically coupled portion such that the ground wire is connected to the hydrogen storing container prior to the fluidly coupled portion being interconnected.

4. The motorcycle of claim 2, wherein the hydrogen storage container comprises a first portion of a mechanical coupling and the attachment member comprises a second portion of a mechanical coupling, the first and second portions of the mechanical coupling interlocking the hydrogen storage container to the attachment member.

5. The motorcycle of claim 4, wherein an insertion hole extends through one of the first portion and the second portion of the mechanical coupling, a guide shaft being provided on another of the first portion and the second portion of the mechanical coupling, the guide shaft being insertable into the insertion hole while making contact with at least a portion of a wall defining the insertion hole.

6. The motorcycle of claim 5, wherein the hydrogen storage container comprises a first fluid coupling portion and the attachment member comprises a second fluid coupling portion, the first and second fluid coupling portions connectable together to fluidly couple the hydrogen storage container and the attachment member.

7. The motorcycle of claim 6, wherein a drum part is provided in one of the first fluid coupling portion and the second fluid coupling portion, an interconnecting hole being provided on the other of the first fluid coupling portion and the second fluid coupling portion, the drum part being is fitted to the interconnecting hole in a substantially airtight manner, a valve body being provided on the first fluid coupling portion such that the valve body is urged to one side to substantially block the space between the drum part and the interconnecting hole, a protruding element being provided on the second fluid coupling portion such that the protruding element urges the valve body away from the one side whereby the drum part and the interconnecting hole are placed into fluid communication when the drum part is engaged with the interconnecting hole.

8. The motorcycle of claim 7, wherein the drum part and the interconnecting hole interconnect when the hydrogen storing container is brought toward the attachment member and the drum part engages with the interconnecting hole while the guide shaft is inserted into the insertion hole.

9. The motorcycle of claim 7, wherein a locking mechanism is provided such that the locking mechanism secures the hydrogen storing container to the attachment member when the drum portion engages with the interconnecting hole.

10. The motorcycle of claim 9, wherein the locking mechanism includes a locked part and a locking part that are capable of engagement, and either one of the locked part or the locking part is provided on the hydrogen storing container and the other is provided on the attachment.

11. The motorcycle of claim 2, wherein the hydrogen storing container comprises an electrically conductive bracket, the bracket comprising a handle and the bracket defining a portion of a mechanical coupling between the hydrogen storing container and the attachment member.

12. The motorcycle of claim 11, wherein the attachment member and the bracket comprise a positioning mechanism, the positioning mechanism guiding the hydrogen storing container into a predetermined position relative to the attachment member.
